(19) United States
(12) Patent Application Publication
(10) Pub. No.: US 2009/0311066 A1
(43) Pub. Date: Dec. 17, 2009

(54) DEVICE FOR DISPLAYING THE CORRECT TIGHTENING FORCE FOR A NUT MOUNTED ON A THREADED ROD

(76) Inventor: Lionel Utille, Faverges (FR)

Correspondence Address: Hershkovitz & Associates, LLC, 2845 Duke Street, Alexandria, VA, 22314, US

(21) Appl. No.: 12/297,593

(22) PCT Filed: Apr. 19, 2006
(86) PCT No.: PCT/FR2006/000906

§ 371 Date: Jan. 26, 2009

(51) Int. Cl. F16B 31/02

(52) U.S. Cl. 411/11

(57) ABSTRACT

A device (1) for displaying the correct tightening force for a nut (7) intended for assembling two elements (2, 3) of a structure (4) by co-action with a threaded rod (60), assembly being effected, for example, by way of a bolt (5) constituted by a screw (6), a nut (7), at least one nondeformable washer, and a display washer made of elastically deformable material such as a synthetic rubber, a natural rubber, an elastomer, or a polyurethane plastic material, wherein at least one of the nondeformable washers has on its inner face a projection (103) whose inner face (101) is intended, after tightening, to abut against the inner face of another washer or against the element to be assembled; and the deformable washer protrudes peripherally as it is crushed, constituting an indicator of proper tightening.

### FIELD OF THE INVENTION

The present invention relates to a device for displaying the correct tightening force for a nut mounted on a threaded rod.

### BACKGROUND OF THE INVENTION

Parts assembled using bolts, i.e. a screw and a nut, or using nuts mounted on studs, are found in a wide variety of products.

In a very large number of applications for assembling parts by co-action of a threaded rod and a nut, the value of the nut tightening force is of little importance. In certain applications, however, it is very important to ensure defined tightening of the nut. One such case is assembly of the elements of a crane, or that of securing a pylori to the ground, a structure of an overhead crane, a mechanical lifting tower, a platform, or other instances such as, for example, a mechanism like a roller coaster.

To allow defined tightening of assembly nuts, designers propose torque wrenches or screwdrivers with calibrated and defined tightening. With the use of such means it is not possible, however, to perform a visual tightening verification; this is a serious handicap for assembled structures comprising sometimes hundreds or even thousands of nuts. These traditional means furthermore do not prevent untimely loosening, which is not visible; this constitutes a serious drawback, because in most cases the devices in question then become dangerous. It is also known that inspection agencies are charged with approving installations, but have at their disposal no means other than verification using a torque wrench.

### OBJECT OF THE INVENTION

The object of the present invention is to eliminate the aforementioned drawbacks, and it proposes a displaying device that is particularly simple, low in cost, and reliable.

According to the present invention, the device for displaying the correct tightening force for a nut intended for assembling two elements of a structure by co-action with a threaded rod is therefore characterized in that the displaying device is constituted by a display washer intended to be put in place beneath the nut, while the display washer is constituted by a deformable washer embodied in an elastic material, having at least on its lower surface a nondeformable washer.

According to a complementary characteristic, the deformable washer is sandwiched between two support washers made of rigid material.

According to another complementary characteristic, the two support washers are coupled to the deformable washer by way of an adhesive bond or a welded join effected by ultrasound or vibration, or by way of a mechanical type of connection.

The elastic washer is furthermore, for example, made of elastomer.

According to a variant embodiment, one of the nondeformable washers has on its inner face a first central projection whose inner face is intended, after tightening, to abut against the inner face of the other washer.

According to yet another variant embodiment, at least one of the nondeformable washers has on its inner face a second peripheral projection whose thickness is less than the thickness of the central projection of the washer.

According to the preferred mode of this variant, the thickness of the peripheral projection increases from the center of the washer outward.

Other characteristics and advantages of the invention will emerge from the description below with reference to the attached drawings, which are provided only as non-limiting examples.

### BRIEF DESCRIPTION OF THE DRAWINGS

FIG. 1 illustrates the device according to the present invention before assembly.

FIG. 2 illustrates the device according to the present invention during assembly but before tightening.

FIG. 3 is an end view of FIG. 2 showing that tightening is not in conformity.

FIG. 4 illustrates the device according to the present invention once tightening of the nut has been performed.

FIG. 5 is an end view illustrating that the nut is correctly tightened.

FIG. 6 is a view illustrating a variant embodiment.

FIGS. 7a, 7b illustrate a variant embodiment; according to FIG. 7a, the display washer is in an inactive, uncompressed position, while FIG. 7b illustrates the same washer after compression.

FIGS. 8a, 8b, 8c illustrate another variant embodiment, FIG. 8a depicting the display washer in a position ready for assembly; FIG. 8b illustrating the washer in the inactive, uncompressed state; and FIG. 8c illustrating the washer after compression.

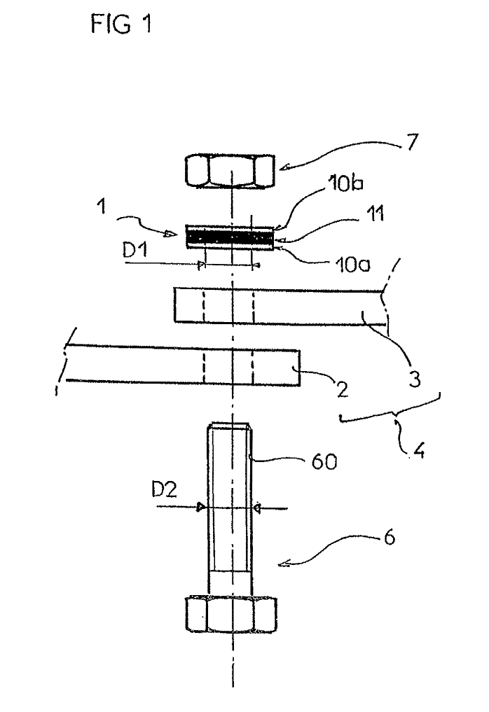

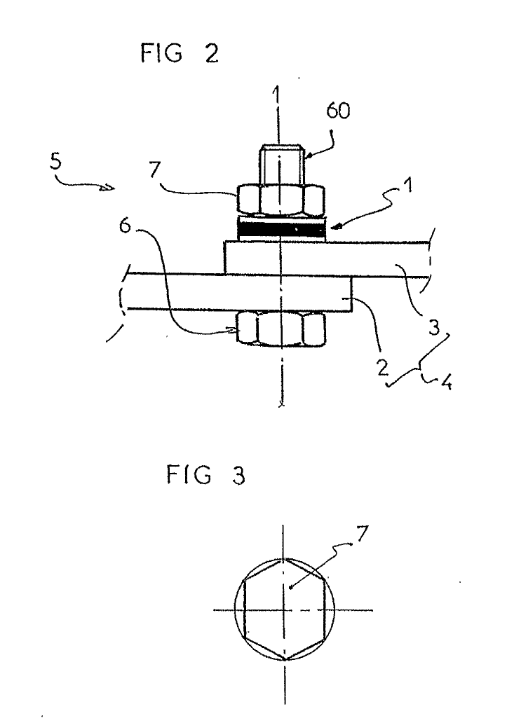

### DETAILED DESCRIPTION OF PREFERRED EMBODIMENTS

Displaying device 1 is intended to be used to assemble two elements 2, 3 that form part of a structure 4, assembly being effected, for example, by way of a bolt 5 constituted by a screw 6 and a nut 7.

The structure can be, for example, a crane, and assembly can involve, for example, two profiled sections; but the structure can also be a pylori secured to the ground by way of studs embedded in a concrete block. The invention can of course relate to all types of structures or assemblies without thereby leaving the scope of the invention.

According to the invention, display device 1 is a display washer intended to be put in place beneath nut 7 and comprises an elastically deformable element that is compressed during the tightening of the nut.

Display washer 1 is thus constituted by a deformable washer 11 made of elastic material, having a nondeformable washer 10a at least on its lower surface.

According to the invention, the display washer is constituted by a deformable washer 11 sandwiched between two support washers 10a, 10b made of a rigid material such as steel. The two support washers 10a, 10b are moreover coupled to deformable washer 11 by clipping, adhesive bonding, or a welded join effected by ultrasound or vibration, or by a mechanical type of connection.

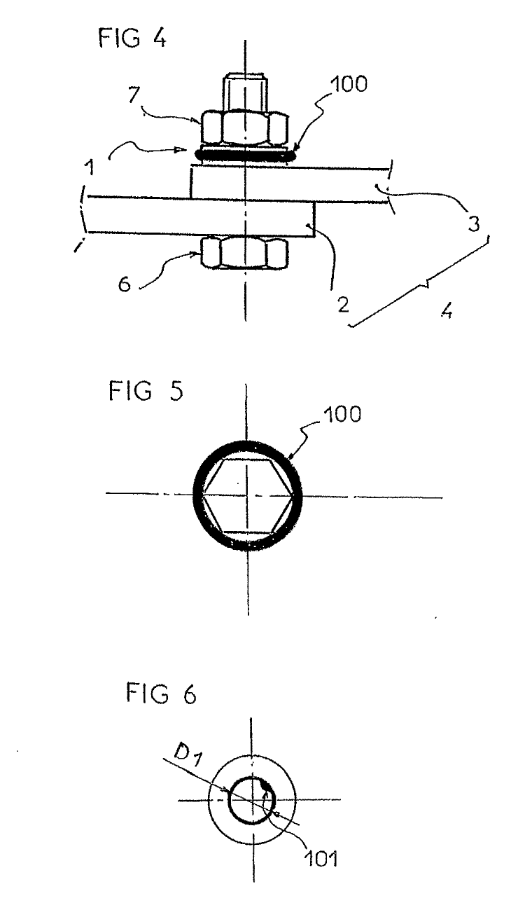

It is evident that as nut 7 is tightened, the elastic washer becomes crushed and is deformed at its periphery, as illustrated in FIGS. 3 and 4; that part 100 of the deformable washer that protrudes peripherally constitutes an indicator of proper tightening. The user can therefore ascertain, by simply glancing at the structure's bolts, that they are properly tightened. It is also evident that if the nut happened to loosen, elastic washer 11 would decompress and the peripherally protruding part would at least partly disappear. The user will then be able to ascertain, by simply glancing at the structure's bolts, whether one or another of them are entirely or partly loosened.

Diameter D1 of the central hole of deformable washer 11 is, for example, larger than diameter D2 of threaded rod 60 of the screw, but the situation could also be different. Specifically, diameter D1 of the central hole of deformable washer 11 could be slightly smaller than diameter D2 of threaded rod 60 of the screw. The displaying device would thus be engaged onto the screw with a certain tightness, allowing it to be retained.

In another embodiment as illustrated in FIG. 5, the central hole of the deformable washer could have a retaining projection 101 extending inward, said such projection thus ensuring retention of the displaying device on the corresponding threaded rod.

It is apparent that once displaying device 1 has been compressed, thanks to its deformable washer it provides an axial thrust on the nut, which decreases the possibility of untimely loosening.

The material of which the elastic washer is made can be, for example, a natural rubber, a synthetic rubber, or an appropriate plastic material such as a polyurethane, an elastomer, or another material. The dimensions and elastic characteristics of the material will of course be selected depending on the desired result.

The material selected could thus be an elastomer having an appropriate Shore hardness and a thickness adapted to the selected conditions.

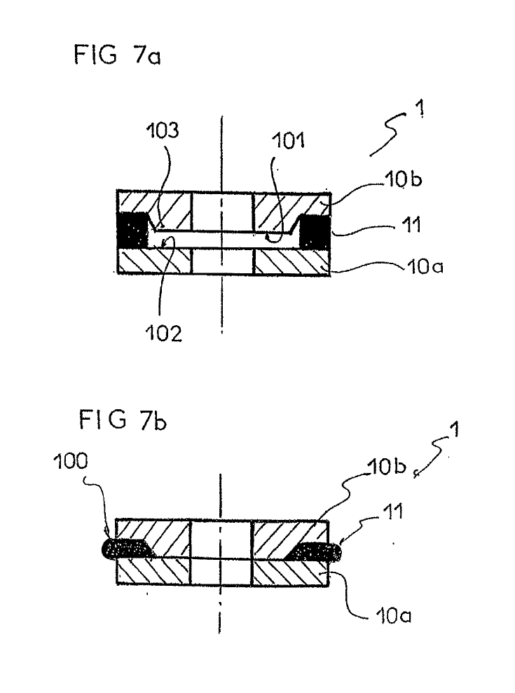

FIGS. 7a, 7b depict a variant embodiment according to which at least one of the nondeformable washers 10a, 10b has on its inner surface a central projection 103 whose inner face 101 is intended, after tightening, to abut against inner face 103 of the other washer 10b or 10a, as illustrated in FIG. 7b.

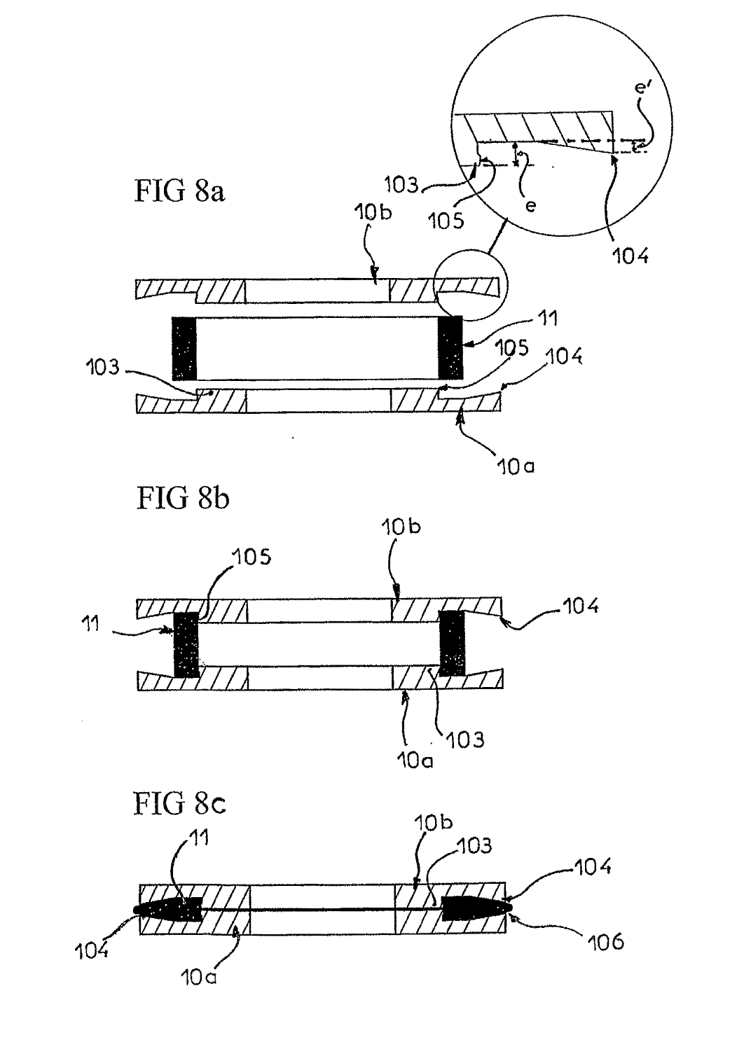

FIGS. 8a to 8c depict another variant embodiment, constituting the preferred mode of the invention, according to which at least one of the nondeformable washers 10a, 10b has on its inner face a second peripheral projection 104.

The thickness e′ of peripheral projection 104 is less than the thickness e of central projection 103, leaving a circular passage 106 for the deformable washer that allows it to be viewed after compression.

According to the embodiment illustrated, the thickness e′ of peripheral projection 104 increases from the center of the washer outward, forming a receptacle for the deformable washer that takes the shape of two conical cups facing one another.

The second peripheral projection 104 allows the deformable washer to retract more quickly, thus allowing incorrect tightening of the nut to be perceived more quickly.

According to another characteristic of the invention, central projection 103 encompasses a peripheral projection 105 oriented outward, allowing the deformable washer to be secured to the nondeformable washer by clipping.

Note also that the deformable washer can be colored, for example yellow, red, orange, blue, or phosphorescent, in order to improve its visibility.

The invention is of course not limited to the embodiments described and depicted by way of example, but also encompasses all technical equivalents and combinations thereof.

1. A device for displaying the correct tightening force for a nut intended for assembling two elements of a structure by co-action with a threaded rod, assembly being effected by way of a bolt constituted by a screw and a nut, the device comprising:
at least one nondeformable washer; and
a display washer made of elastically deformable material comprising:
one of synthetic rubber, a natural rubber, an elastomer and a polyurethane plastic material,
wherein at least one of the nondeformable washers has on its inner face a projection whose inner face is intended, after tightening, to abut against the inner face of another washer or against the element to be assembled, and the deformable washer protrudes peripherally as it is crushed, constituting an indicator of proper tightening.

2. The displaying device according to claim 1, wherein at least one of the nondeformable washers has on its inner face a second peripheral projection.

3. The displaying device according to claim 2, wherein the thickness of the second peripheral projection is less than the thickness of the first projection having the mechanical carrying function.

4. The displaying device according to claim 3, wherein the thickness of the second peripheral projection increases from the center of the washer outward.

5. The displaying device according to claim 1, wherein the deformable washer is sandwiched between two support washers made of rigid material.

6. The displaying device according to claim 5, wherein the two support washers are coupled to the deformable washer by way of an adhesive bond or a welded join effected by ultrasound or vibration, or by way of a mechanical type of connection.

7. The displaying device according to claim 1, wherein the deformable washer is colored, for example with the colors of yellow, red, orange, or blue, to improve its visibility.

8. The displaying device according to claim 1, wherein the diameter of the central hole of the deformable washer is slightly smaller than the diameter of the threaded rod, so that the displaying device is engaged onto the screw with a certain tightness.

9. The displaying device (1) according to claim 1, wherein the central hole of the deformable washer has a retaining projection extending inwardly, said projection thus ensuring retention of the displaying device on the corresponding threaded rod.

10. The displaying device according to claim 5, wherein the deformable washer is colored with the colors comprising yellow, red, orange or blue to improve its visibility.

11. The displaying device according to claim 5, wherein the diameter of the central hole of the deformable washer is slightly smaller than the diameter of the threaded rod, so that the displaying device is engaged onto the screw with a certain tightness.

12. The displaying device according to claim 5, wherein the central hole of the deformable washer has a retaining projection extending inwardly, said projection thus ensuring retention of the displaying device on the corresponding threaded rod.
